(19) United States
(12) Patent Application Publication
(10) Pub. No.: US 2005/0172334 A1
(43) Pub. Date: Aug. 4, 2005

(54) Automatic coding system memory cards

(75) Inventor: Chien-Yuan Chen, Banchiau City (TW)

Correspondence Address: TROXELL LAW OFFICE PLLC;SUITE 1404, 5205 LEESBURG PIKE, FALLS CHURCH, VA, 22041, US

(73) Assignees: Power Digital Card Co., Ltd.; Chien-Yuan Chen

(21) Appl. No.: 10/766,830

(22) Filed: Jan. 30, 2004

(51) Int. Cl. H04K 1/00

(52) U.S. Cl. 726/9; 713/185

(57) ABSTRACT

The invention relates to an automatic coding system memory, which sets up the automatic coding system memory card with a security identification or various security identifications on the control chip of the memory card to be compounded into an digital-management capability of keeping inter-confidential the content of the memory card and the memory card itself by both the hardware and software without installing the protection chip on the loading hardware to the function of achieving and popularizing the web digital-management.

### BACKGROUND OF THE INTENTION

(a) Field of the Invention

The invention relates to an automatic coding system memory card, especially to which owns a security identification or various security identifications on the control chip of the memory card.

(b) Description of the Prior Art

With the rapid development of the Internet era, the business relative to internet wireless on-line have also expanded quickly. For the time being, the basic problem with the difficulty to carry out the digital-management consist is the technique of integrating the content and device. The conventional way is burning copying the content on the chip which has protecting functions of protection and then loading the content by its compatible device.

### SUMMARY OF THE INVENTION

Therefore, in consideration of the afore-mentioned defects, the main objective of the invention is to provide an automatic coding system memory card, which has a security identification or various security identifications configured on control chip of a memory card, to perform digital-management capability whereby keeping inter-confidential between the content within the memory card and the memory card itself applied by relative hardware and software thereof without installing a protection chip on a loading hardware thereby enabling the functional internet digital-management being widespread.

In order that the examiner know and understand better the characteristic, purpose and functions of this invention, hereinafter state in details in accordance with the drawings:

### BRIEF DESCRIPTION OF THE DRAWINGS

FIG. 1 is the functional diagram of the invention.

FIG. 2 is the functional diagram of the downloaded content of the invention.

### DETAILED DESCRIPTION OF THE PREFERRED EMBODIMENTS

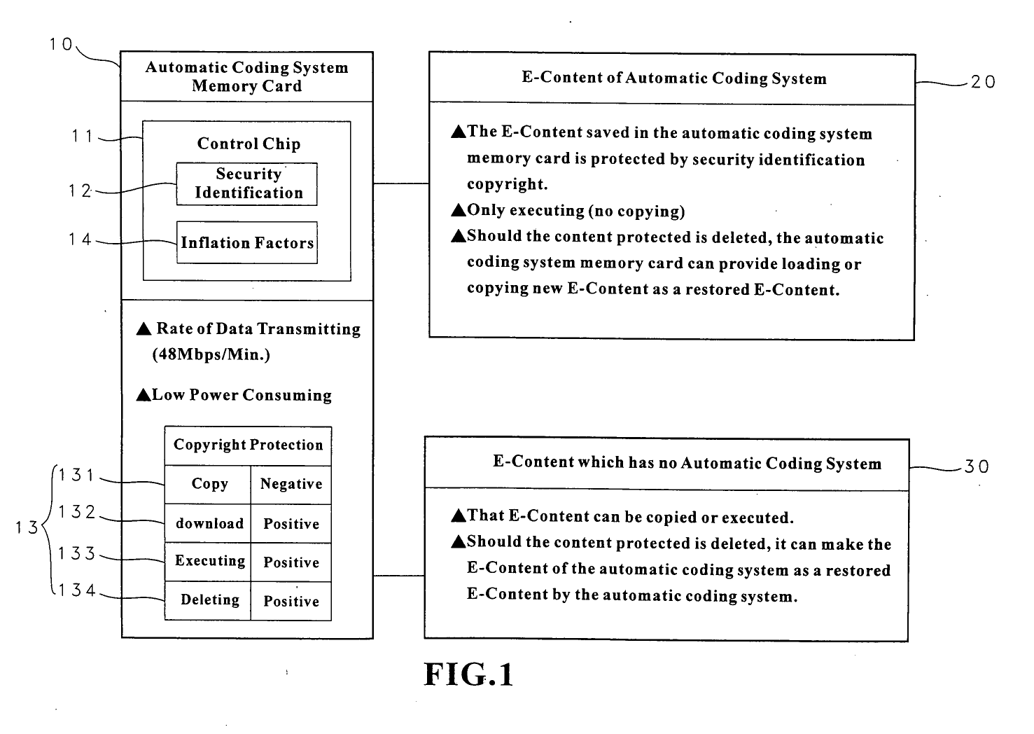

Referring to FIG. 1, an automatic coding system card 10 includes a control chip 11 integrated with SID (Security Identification) 12 and inflation factors 14, wherein, the rate set-up for data transmitting of the automatic coding system card 10 is 48 Mbps/min. The SID 12 provides the consumers with various kinds of copyright protection, including copy prohibited 131, loading available 132, executing available 133, and deleting available 134. The automatic coding system card 10 is provided with saving or transmitting digital content with automatic coding system 20 or digital content without automatic coding system 30. The digital content with automatic coding system 20 has features as follows:
1), The digital content saved in the automatic coding system memory card is protected by copyright with security identification.
2), It is executable only (not copied).
3), If the digital content protected should be deleted, the automatic coding system memory card can provide downloaded or copied digital content for restoring purposes.

The digital content without automatic coding system has the following features:
1), The digital content is copyable and executable.
2), If the digital content protected should be deleted, the digital content from automatic coding system memory card can be provided or copied as a restored digital content.

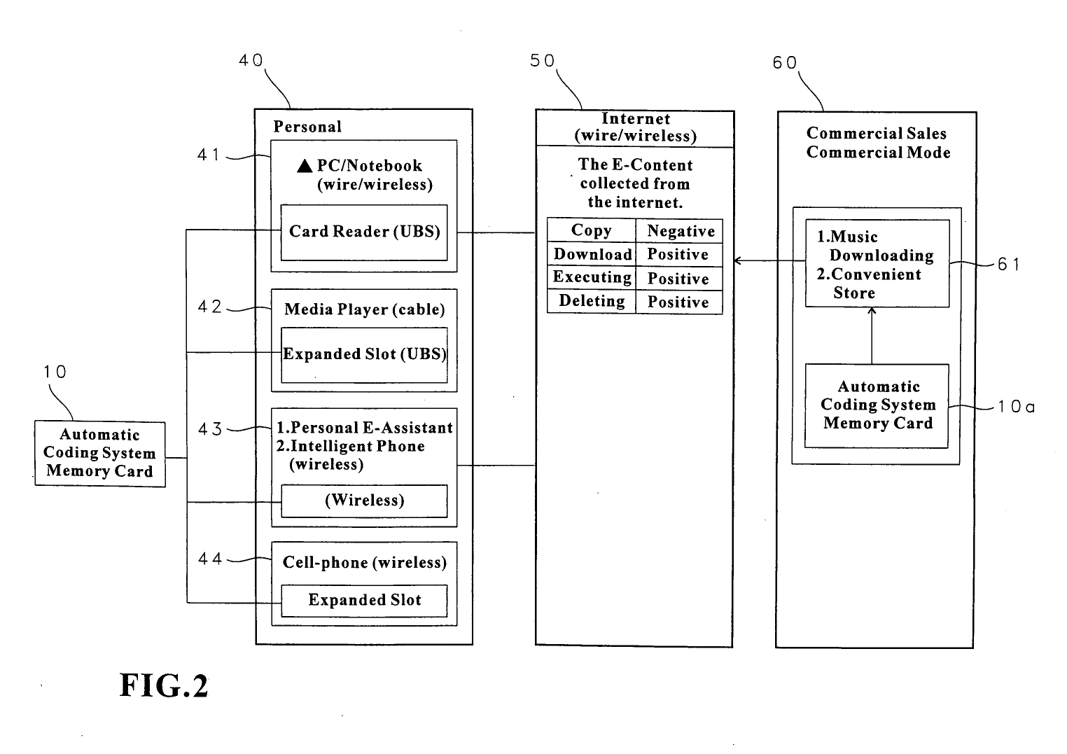

Referring to FIG. 2, the automatic coding memory card 10 can be connected with different personal-use hardware 40 such as wire or wireless PC/notebook 41, card reader 45 with USB (Universal Serial Bus), cable media player 42 with USB, personal digital assistant 43 or wireless smart phone 44, etc. The wire or wireless PC/notebook 41 is connected with wire or wireless network 50, which is connected with an end of commercial sale 60, The commercial sale 60 can be used for downloadable music or convenient store 61, which can retrieve another automatic coding system memory card 10a.

Referring to FIG. 1 and FIG. 2 at the same time, the SID 12 configured on the automatic coding system memory card 10 is designed to protect the digital content 20 with automatic coding system contained in the automatic coding system memory card 10, but not to protect the digital content 30 without automatic coding system. Moreover the control chip 11 on the automatic coding system memory card 10 can save the same content which has different SID 12 therein, thereby enabling individually protecting the content of the automatic coding system memory card 10.

When the automatic coding system memory card 10 is applied to internet consuming system, that system can only allow consumers download and save the automatic coding system memory card 10 which has SID therein, further allowing the SID with the downloaded content being integrated and saved into the automatic coding system memory card 10.

When the automatic coding system memory card 10 is applied to the media player 42, the media player 42 can play directly by the automatic coding system memory card 10 without saving the content which has SID therein to a register of the media player 42. As soon as the media player 42 plays, it pre-checks and verifies the SID of the automatic coding system memory card 10 to see if it's conform or not. If it does not conform, the media player will not play, furthermore, the inflation factors 14 will inflate the memory space into negligible files.

It is of course to be understood that the embodiment described herein is merely illustrative of the principles of the invention and that a wide variety of modifications thereto may be effected by persons skilled in the art without departing from the spirit and scope of the invention as se forth in the following claims.

1. An automatic coding system memory card comprising a memory card and a control chip, wherein, the control chip further comprising automatic coding system therein.

2. The automatic coding system memory card as recited in claim 1, wherein, the automatic coding system having at least one SID (Security Identification).

3. The automatic coding system memory card as recited in claim 2, wherein, the SID protecting digital content of the memory card having an automatic coding system therein, while the digital content of the memory card without an automatic coding system not being protected.

4. The automatic coding system memory card as recited in claim 2, wherein, each of the same content of the memory card being individually saved and protected by different SID (Security Identification).

5. The automatic coding system memory card as recited in claim 2, wherein, the memory card applying to internet consuming system, allowing consumers' downloading and saving in the memory card having SID (Security Identification) therein, further integrating the SID (Security Identification) with content downloaded and then saving into the memory card.

6. The automatic coding system memory card as recited in claim 2, wherein the memory card applying to a media player, the media player being played directly by the memory card without saving the content having the SID (Security Identification) therein the register of the media player.

7. The automatic coding system memory card as recited in claim 6, wherein the media player checking if conformity with the SID (Security Identification) of the memory card before playing, the media player not playing if not conformity therewith.

8. The automatic coding system memory card as recited in claim 1, wherein, the control chip further comprising inflation factors, the memory card verifying if the SID (Security Identification) of the memory card conforming to hardware being saved; the inflation factors inflating memory space into negligible files if not conformity therewith.

9. The automatic coding system memory card as recited in claim 2, wherein, the control chip further comprising inflation factors, the memory card verifying if the SID (Security Identification) of the memory card conforming to hardware being saved; the inflation factors inflating memory space into negligible files if not conformity therewith.

10. An automatic coding system memory card comprising at least one SID (Security Identification) configured on a control chip of a memory card.

11. The automatic coding system memory card as recited in claim 9, wherein, the SID (Security Identification) protecting the digital content of the memory card having an automatic coding system therein, while the digital content of the memory card without the automatic coding system not being protected.

12. The automatic coding system memory card as recited in claim 9, wherein, each of the same content of the memory card being individually saved and protected by different SID (Security Identification).

13. The automatic coding system memory card” as recited in claim 9, wherein, the memory card applying to internet consuming-system allowing consumers downloading and saving the memory card having SID (Security Identification) therein, further integrating the SID with content downloaded and saving into the memory card.

14. The automatic coding system memory card as recited in claim 9, wherein the memory card applying to a media player; the media player being played directly by the memory card without saving the content having the SID (Security Identification) therein the register of the media player.

15. The automatic coding system memory card as recited in claim 13, wherein, the media player checking if conforming with the SID (Security Identification) of the memory card before playing; the media player not playing if not conformity therewith.

16. The automatic coding system memory card as recited in claim 9, wherein, the control chip further comprising inflation factors, the memory card verifying if the SID (Security Identification) of the memory card conforming to the hardware being saved; the inflation factors inflating the memory space into negligible files if not conformity therewith.
